(19) United States
(12) Patent Application Publication
(10) Pub. No.: US 2017/0214492 A1
(43) Pub. Date: Jul. 27, 2017

(54) METHOD AND APPARATUS FOR PACKET RETRANSMISSION

(71) Applicant: Alcatel Lucent, Boulogne Billancourt (FR)

(72) Inventors: Yong Liu, Shanghai (CN); Dong Li, Shanghai (CN); Yanli Xu, Shanghai (CN)

(73) Assignee: Alcatel Lucent, Boulogne Billancourt (FR)

(21) Appl. No.: 15/114,238

(22) PCT Filed: Jan. 19, 2015
(86) PCT No.: PCT/IB2015/000189

§ 371 Date: Jul. 26, 2016

(30) Foreign Application Priority Data
Jan. 29, 2014 (CN) 201410043943.2

(51) Int. Cl. H04L 1/08; H04L 1/06; H04L 1/04; H04L 25/02; H04L 1/18

(52) U.S. Cl. CPC H04L 1/08; H04L 25/0204; H04L 1/1819; H04L 1/04; H04L 1/0612

(57) ABSTRACT

Example embodiments of the present invention provide a method and apparatus for packet retransmission. The method comprises binding a plurality of consecutive packets of the device to obtain a bound packet. The method further comprises transmitting the bound packet for multiple times in at least one of a time domain and a frequency domain, wherein at least one of a time interval and a frequency interval is present between every two consecutive transmissions. Through binding a plurality of consecutive packets into one bound packet and transmitting the bound packet for multiple times at a time interval and/or a frequency domain interval in the time domain and/or the frequency domain, upon reception of the packet, not only the gain obtained by joint channel estimation across a plurality of subframes is maintained, but also the time diversity gain and the frequency domain diversity gain may also be obtained for each of the plurality of consecutive packets, thereby enhancing link performance.

### FIELD OF THE INVENTION

Example embodiments of the present invention relate to the field of communication, and more specifically to a method and apparatus for packet retransmission.

### BACKGROUND OF THE INVENTION

In the communication system, in order to transmit data to a receiving end device as far as possible, the link-level performance needs to be enhanced. Particularly for broadcast communication, for example, a device-to-device (D2D) broadcast communication, distances between receiving end devices and a transmitting end device are different. In order to enable a receiving end device far from the transmitting end device to receive the broadcast data, effective packet retransmission can be applied so as to enhance the gain of receiving the data.

Currently, a method of performing packet retransmission using TTI binding techniques has been proposed. First, a plurality of identical or different redundancy versions of the same packet are bound, and then the bound packet is transmitted. For example, as shown in FIG. 1, two redundancy versions of the packet N are bound, and then the bound packet is transmitted using two 1 ms-subframes, such that the packet N is transmitted twice. For the packet N+1, retransmission may also performed using the same manner.

According to the existing packet retransmission manner, a plurality of redundancy versions of the same packet are bound to be transmitted, such that joint channel estimation across a plurality of subframes may be performed at the receiving end, thereby obtaining certain gains. However, because packets of a plurality of different redundancy versions are located in consecutive timeslots in the time domain, and there are no frequency intervals in the frequency domain, the time diversity gain and frequency diversity gain of the received packet is so minor that the overall link-level performance is still poor.

### SUMMARY OF THE INVENTION

In view of the technical problems existing in the prior art, various embodiments of the present invention provide a method and apparatus for packet retransmission.

According to one aspect of the present invention, there is provided a method for packet retransmission. The method comprises binding a plurality of consecutive packets of the device to obtain a bound packet. The method further comprises transmitting the bound packet for multiple times in at least one of a time domain and a frequency domain, wherein at least one of a time interval and a frequency interval is present between every two consecutive transmissions.

According to one embodiment of the present invention, each packet included in the bound packet is a packet of the same redundancy version during the multiple times of transmission. According to a further embodiment of the present invention, each packet included in the bound packet is a packet of a different redundancy version during the multiple times of transmission.

According to one embodiment of the present invention, when a bound packet is transmitted for multiple times in the time domain, the time interval between every two consecutive transmissions is set to obtain a time diversity gain. According to a further embodiment of the present invention, when a bound packet is transmitted for multiple times in the time domain, the last transmission occurs within a predetermined tolerable transmission delay time.

According to one embodiment of the present invention, when a bound packet is transmitted for multiple times in the frequency domain, the frequency interval between every two consecutive transmissions is set to obtain a frequency diversity gain. According to a further embodiment of the present invention, when a bound packet is transmitted multiple times in the frequency domain, the bound packet is transmitted in a different subframe each time. According to a still further embodiment of the present invention, an entire transmission band is divided into a plurality of sub-bands, and transmitting the bound packet for multiple times in the frequency domain includes transmitting the bound packet on a different sub-band each time.

According to one embodiment of the present invention, the device is a base station or a user terminal.

According to a second aspect of the present invention, there is provided an apparatus for packet retransmission. The apparatus comprises a binding module configured to bind a plurality of consecutive packets of the device to obtain a bound packet. The apparatus further comprises a retransmitting module configured to transmit the bound packet for multiple times in at least one of a time domain and a frequency domain, wherein at least one of a time interval and a frequency interval is present between every two consecutive transmissions.

According to one embodiment of the present invention, each packet included in the bound packet is a packet of the same redundancy version during the multiple times of transmission. According to a further embodiment of the present invention, each packet included in the bound packet is a packet of a different redundancy version during multiple times of transmission.

According to one embodiment of the present invention, when a bound packet is transmitted for multiple times in the time domain, the time interval between every two consecutive transmissions is set to obtain a time diversity gain. According to a further embodiment of the present invention, when a bound packet is transmitted for multiple times in the time domain, the last transmission occurs within a predetermined tolerable transmission delay time.

According to one embodiment of the present invention, when a bound packet is transmitted for multiple times in the frequency domain, the frequency interval between every two consecutive transmissions is set to obtain a frequency diversity gain. According to a further embodiment of the present invention, when a bound packet is transmitted multiple times in the frequency domain, the bound packet is transmitted in a different subframe each time. According to a still further embodiment of the present invention, an entire transmission band is divided into a plurality of sub-bands, and the retransmitting module is further configured to transmit the bound packet on a different sub-band each time.

According to some embodiments of the present invention, through binding a plurality of consecutive packets into one bound packet and transmitting the bound packet for multiple times at a time interval and/or a frequency domain interval in the time domain and/or the frequency domain, upon reception of the packet, not only the gain obtained by joint channel estimation across a plurality of subframes is maintained, but also the time diversity gain and the frequency domain diversity gain may also be obtained for each of the plurality of consecutive packets, thereby enhancing link performance.

### BRIEF DESCRIPTION OF THE ACCOMPANYING DRAWINGS

The above and other objectives, features and advantages of the embodiments of the present invention will become more comprehensible from the detailed description with reference to the accompanying drawings. In the accompanying drawings, several embodiments of the present invention are illustrated in an exemplary and non-limitative manner, wherein:

FIG. 1 illustrates a schematic diagram of packet retransmission using TTI binding techniques in the prior art;

FIG. 2 illustrates a block diagram of an exemplary apparatus adapted for implementing the embodiments of the present invention;

FIG. 3 illustrates a flow diagram of a method for packet retransmission according to an embodiment of the present invention;

FIG. 4 illustrates a schematic diagram of binding and retransmission of a plurality of consecutive packets according to an embodiment of the present invention;

FIG. 5 illustrates a flow diagram of a method for packet retransmission according to another embodiment of the present invention;

FIG. 6 illustrates a schematic diagram of binding and retransmission of a plurality of consecutive packets according to another embodiment of the present invention;

FIG. 7 illustrates a flow diagram of a method for packet retransmission according to a further embodiment of the present invention;

FIG. 8 illustrates a schematic diagram of binding and retransmission of a plurality of consecutive packets according to a further embodiment of the present invention;

FIG. 9 illustrates a schematic diagram of binding and retransmission of a plurality of consecutive packets according to a still further embodiment of the present invention; and

FIG. 10 illustrates a block diagram of an apparatus for packet retransmission according to one embodiment of the present invention.

### DETAILED DESCRIPTION OF THE PREFERRED EMBODIMENTS

Hereinafter, the principle and spirit of the present invention will be described with reference to a plurality of exemplary embodiments shown in the drawings. It should be understood that these embodiments are described only for enabling those skilled in the art to further implement the present invention, not intended to limit the scope of the present invention in any manner.

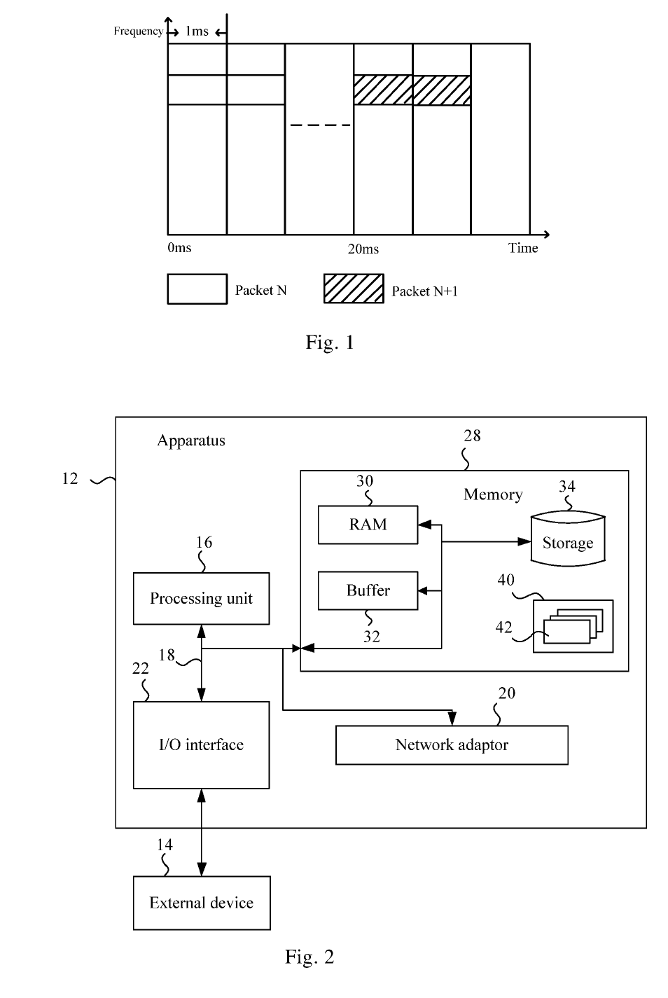

FIG. 2 illustrates a block diagram of an exemplary apparatus 12 adapted for implementing the embodiments of the present invention. The apparatus 12 as shown in FIG. 2 is only an example, which should not constitute any limitation to the function and use scope of the embodiments of the present invention.

As shown in FIG. 2, the apparatus 12 is shown in the form of a general-purpose computing device. The device may be a base station or a user terminal, including, but not limited to: eNode, eNodeB, a network node, a relay node, a server, or a mobile phone, a notebook computer, a desktop computer, a portable computer, a personal digital assistant (PDA), a tablet computer, etc. Components of the apparatus 12 may include, but are not limited to: one or more processors or processing units 16, and a bus 18 connecting different system components (including a system memory 28 and a processing unit 16).

Bus 18 represents one or more of any of several kinds of bus structures, including a memory bus or a memory controller, a periphery bus, an accelerated graphics port, and a processor or a local area bus using any bus structure among a plurality of bus structures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The apparatus 12 typically includes a variety of computer system readable mediums. These mediums may be any available medium accessible to the apparatus 12, including volatile and non-volatile mediums, mobile and immobile mediums.

The system memory 28 may comprise a computer system readable medium in the form of volatile memory, e.g., a memory 30 and/or a buffer 32. The apparatus 12 may further comprise other mobile/immobile, volatile/non-volatile computer system storage mediums. Although not shown in FIG. 2, a disk driver that may read/write the mobile non-volatile disk (e.g., “floppy disk”), and an optical disk driver that reads/writes the mobile non-volatile optical disk (e.g., CD-ROM, DVD-ROM, or other optical medium). In these cases, each driver may be connected to the bus 18 through one or more data medium interfaces. The memory 28 may include at least one program product, which program product has a set (e.g., at least one) of program modules. These program modules are configured to perform the functions of various embodiments of the present invention.

A program/utility tool 40 having a set (at least one) of the program module 42 may be stored in, e.g., a memory 28. Such program module 42 includes, but not limited to, an operating system, one or more applications, other program modules, and program data; each or a certain combination of these examples might include implementation of the network environment. The program module 42 generally performs the functions and/or methods in the embodiments described in the present invention.

According to the needs, the apparatus 12 may also communicate with one or more peripheral devices 14 (e.g., display device, external storage device, etc.), but also communicate with one or more devices enabling the user to interact with the apparatus 12, and/or communicate with any device (e.g., network card, modem, etc.) enabling the apparatus 12 to communicate with one or more other computing devices. This communication may be performed through an input/output (I/O) interface 22. Moreover, the apparatus 12 may also communicate with one or more networks (e.g., local area network (LAN), wide area network (WAN) and/or public network, e.g., Internet) through a network adaptor 20. As shown in the figure, the network adaptor 20 communicates with other module of the apparatus 12 via the bus 18. It should be noted that although not shown in the figure, other hardware and/or software module may be used in conjunction with the apparatus 12, including, but not limited to: microcode, device driver, redundant processing unit, external disk driving array, RAID system, disk driver, and data backup storage system, etc.

It should be noted that FIG. 2 only illustrates a block diagram of an apparatus 12 that can implement the present invention, and those skilled in the art may also employ other device to implement various embodiments of the present invention.

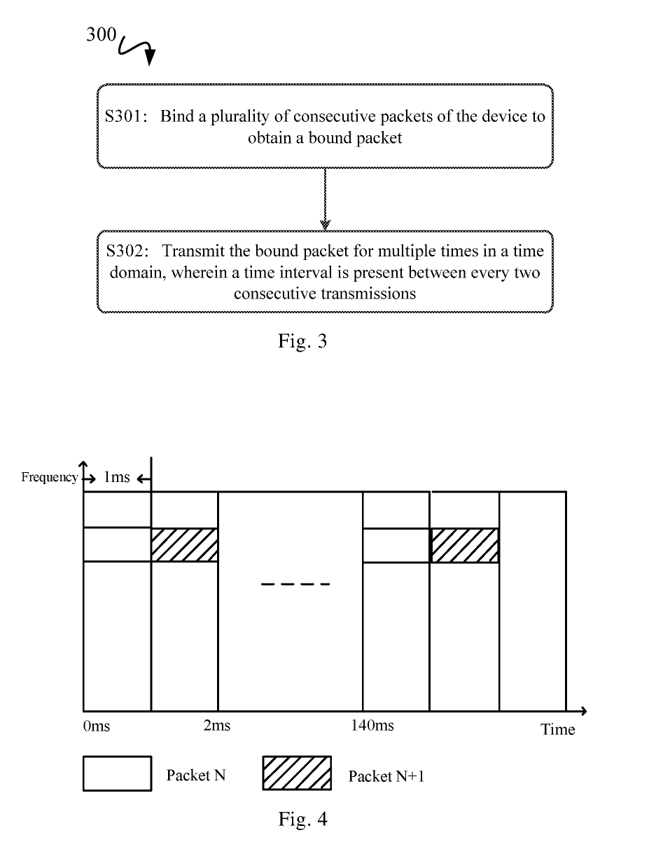

FIG. 3 shows a flow diagram of a method 300 for packet retransmission according to an embodiment of the present invention. It should be understood that the method 300 may also comprise additional steps and/or omit performing an illustrated step. The scope of the present invention is not limited in this regard.

After the method 300 starts, at step S301, a plurality of consecutive packets of the device are bound to obtain a bound packet.

According to the embodiments of the present invention, the device may be a base station, a user terminal, or any other device that demands to transmit a packet to another device.

Among packets to be transmitted to a further apparatus, a plurality of consecutive packets may be bound together to obtain a bound packet. In an embodiment of the present invention, the number of consecutive packets in one bound packet is not limited. In one example, the number of consecutive packets bound in one bound packet may be pre-determined, and the determined number is notified to the receiving end device.

According to one embodiment of the present invention, if the packets that need transmission are not consecutively obtained, then after one packet is obtained, it can wait for subsequent packets until obtaining the predetermined number of consecutive packets.

For example, in a periodical VoIP service, the voice encoder generates a voice packet every 20 ms. If two consecutive packets can be bound together, after the first voice packet is generated, it waits for 20 ms before obtaining the second voice packet. Then, the two voice packets may be bound into one bound packet.

Next, the method 300 proceeds to step S302. At step S302, the bound packet is transmitted for multiple times in a time domain, wherein a time interval is present between every two consecutive transmissions.

Herein, the receiving end device of the transmission of the bound packet may also be a base station or a user terminal. In order to transmit the packet data to the receiving end device as far as possible, or in order to correctly transmit packet data, the bound packet may be transmitted for multiple times in the time domain.

According to an embodiment of the present invention, the time interval between every consecutive two transmissions is set to obtain a time diversity gain. Those skilled in the art may know that a plurality of retransmissions expanded over time may result in the time diversity gain if there is a time interval between every two consecutive transmissions and the time interval is relatively sufficient. The time interval between multiple transmissions may be adjusted according to the actual conditions. In one example, the time interval between every two consecutive transmissions may be greater than a channel coherence time. In other examples, the time interval between every two consecutive transmissions may be less than or equal to the channel coherence time. It should be noted that the time intervals between every two consecutive transmissions among the plurality of transmissions may be identical or different.

The larger the time interval between transmissions is, the greater is the time diversity gain upon reception of the bound packet. For each packet within the bound packet, its time diversity gain may also increase.

Different data transmission services have their own tolerable transmission delay. According to a further embodiment of the present invention, upon packet retransmission, the last transmission may occur within a predetermined transmission delay time. For example, requirement for the transmission delay in the VoIP service is 200 ms. When binding a plurality of consecutive packets, with deduction of the wait time for the packet generation (e.g., for a binding including two consecutive packets, deducting 20 ms) and other processing time, the tolerable transmission delay for packet retransmission in a one-way transmission is about 160 ms. Upon packet retransmission, the time interval between the last transmission and the first transmission may be less than 160 ms.

In one embodiment of the present invention, the bound packet may be transmitted automatically for multiple times, and the times of transmission may also be pre-determined. For example, in the VoIP service, the times of retransmission may be pre-determined, and each bound packet is transmitted according to the predetermined times of retransmission. In a further embodiment of the present invention, the bound packet may be retransmitted based on the HARQ (Hybrid Automatic Repeat Request) feedback or other feedback from the receiving end device.

For example, as shown in FIG. 4, two packets (packet N and packet N+1) from the device are bound to obtain a bound packet. Suppose transmission is performed in an LTE system, and each packet seizes a 1 ms subframe, then the bound packet seizes 2 subframes. During 0-2 ms, the bound packet is first transmitted. Afterwards, based on a predetermined time interval, the bound packet is continuously transmitted. For the VoIP service, the tolerable transmission delay time is 160 ms, and at a subframe less than 160 ms, e.g., at 140-142 ms, the bound packet is transmitted for the last time.

According to a further embodiment of the present invention, among the plurality of consecutive packets included in the bound packet, each packet may have a plurality of different redundancy versions. In one embodiment of the present invention, each packet included in the bound packet is a packet of an identical redundancy version during the multiple transmissions. In other words, each packet included in the bound packet keeps its redundancy version unchanged during the multiple times of transmission. In a further embodiment of the present invention, each packet included in the bound packet is a packet of a different redundancy version during the multiple times of transmission. Therefore, at least one packet included in the bound packet has its redundancy version changed in each time of transmission. In one example, each packet included in the bound packet changes its redundancy version according to a fixed sequence of redundancy versions. The fixed sequence of redundancy versions includes a series of redundancy versions of the packet. During the multiple times of transmission, a different redundancy version of a packet is transmitted each time, so as to obtain an incremental redundancy gain for the packet. According to an embodiment of the present invention, if the bound packet of an identical redundancy version or a different redundancy version is transmitted each time, at the receiving end device, the currently known Chase combination method of or other known manner may be employed to receive the bound packet.

Further, because a plurality of consecutive packets are bound into one bound packet, according to one embodiment of the present invention, upon reception of the bound packet, a joint channel estimation across a plurality of subframes may be employed to decode the bound packet so as to obtain a further gain.

A time hopping pattern according to the embodiments of the present invention has been described above with reference to FIGS. 3 and 4, where a bound packet consisting of a plurality of consecutive packets is transmitted in the time domain with a certain time interval span, thereby obtaining the time diversity gain of the packet and enhancing the link performance. It may be seen that the time hopping pattern may introduce an additional transmission delay. For a communication service with a relatively large tolerable transmission delay time, e.g., the VoIP service, such transmission delay is acceptable.

Further, with reference to FIG. 5, in order to reduce the transmission delay, another embodiment of the present invention further provides a span transmission in the frequency domain.

FIG. 5 shows a flow diagram of a method 500 for packet retransmission according to another embodiment of the present invention. It should be noted that the method 500 may also comprise additional steps and/or omitting performing the shown steps. The scope of the present invention is not limited in this regard.

After the method 500 starts, at step S501, a plurality of consecutive packets of the device are bound to obtain a bound packet.

Step S501 is similar to step S301, detailed depiction of which is omitted here for the sake of clarity. For details, please refer to the above depiction with respect to step S301.

At step S502, the bound packet is transmitted for multiple times in the frequency domain, wherein a frequency interval is present between every two consecutive transmissions.

Herein, the receiving end device of the transmission of the bound packet may also be a base station or a user terminal. In order to transmit the packet data to the receiving end device as far as possible, or in order to correctly transmit the packet data, the bound packet may be transmitted for multiple times in the frequency domain.

According to the embodiments of the present invention, the frequency interval between every two consecutive transmissions is set to obtain the frequency diversity gain. Those skilled in the art may know that multiple times of retransmission expanded over frequency may obtain the frequency diversity gain if there is a frequency interval between every two consecutive transmissions and the frequency interval is relatively sufficient. In one example, the frequency interval between every two consecutive transmissions may be greater than the channel coherent bandwidth. In other examples, the frequency interval between every two consecutive transmissions may be less than or equal to the channel coherent bandwidth. It should be noted that the frequency intervals between every two consecutive transmissions among a plurality of transmissions may be identical or different.

With the increase of the frequency interval between transmissions, the frequency diversity gain may increase upon reception of the bound packet. For each packet within the bound packet, its frequency diversity gain may also increase.

When the bound packet is transmitted for multiple times in the frequency domain, in one embodiment, the bound packet may be transmitted in the same subframe at different frequencies each time.

In another embodiment, when transmitting the bound packet for multiple times in the frequency domain, the bound packet is transmitted in a different subframe each time. In this embodiment, besides having a frequency interval, transmission of the bound packet may not overlap over time either, which mainly has took the following two reasons into account:

1) The transmission power of the apparatus is limited. Transmitting the plurality of bound packets in the same subframe at different frequencies may result in deterioration of a unit of bandwidth power, which may affect the transmission quality of the bound packet.

2) Transmission in the same subframe may require the use of consecutive subcarriers to maintain a low PAPR (Peak to Average Power Ratio). In this embodiment, a certain frequency interval is required between any two transmissions. If multiple transmissions are performed in the same subframe, the subcarriers used for each transmission are non-continuous, which may cause a higher PAPR.

Besides, in order to simplify reception of the bound packet at the receiving end device, according to an embodiment of the present invention, the entire transmission frequency band may also be divided into a plurality of sub-bands, and multiple transmission of the bound packet in the frequency domain includes transmitting the bound packet on a different sub-band each time. Therefore, the receiving end device may not be required to detect the bound packet on the entire transmission band each time; instead, it is only required to detect the bound packet on a corresponding sub-band each time. In an embodiment of the present invention, the number of sub-bands as divided may be pre-configured based on different factors such as the entire transmission bandwidth. Suppose the entire transmission bandwidth is N_{b} RBs (resource blocks), and the number of divided sub-bands is Ns, then each sub-band has a bandwidth of N_{b}/Nₛ RBs. Herein, each time when the bound packet is transmitted on a sub-band, the transmission may be performed at any frequency or a fixed frequency within the sub-band, the embodiments of the present invention are not limited in this regard, as long as a predetermined or any frequency interval is present between any two transmissions.

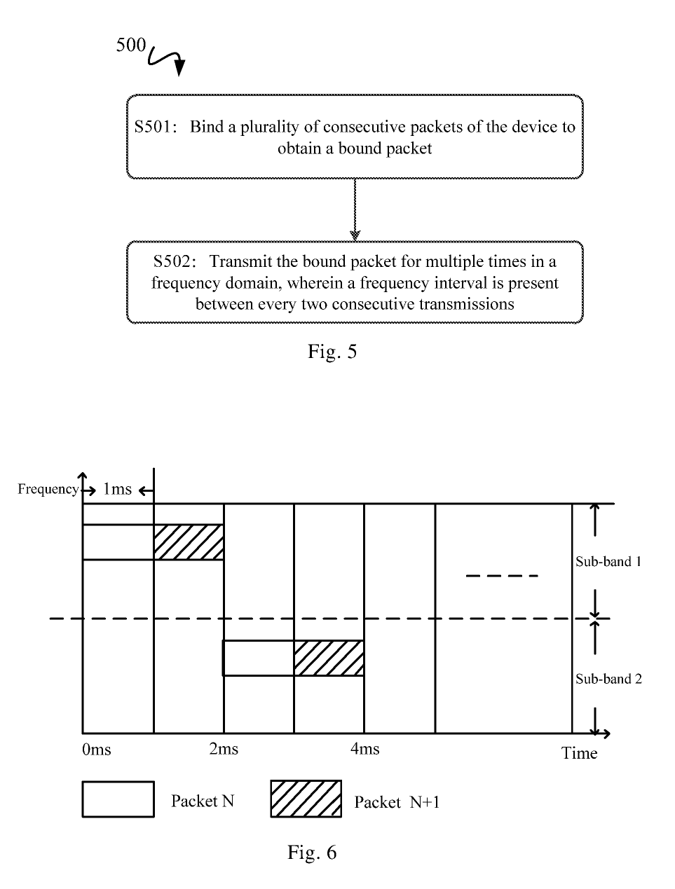

As shown in FIG. 6, two packets (packet N and packet N+1) from the device are bound to obtain a bound packet. Suppose transmission is performed in an LTE system, and each packet seizes 1 ms subframe, then the bound packet seizes 2 subframes. In FIG. 6, the overall transmission frequency band is divided into two sub-bands (i.e., sub-band 1 and sub-band 2), each sub-band has 25 RBs. In the subframes of 0-2 ms, at the second RB in sub-band 1, i.e., the second RB of the entirety frequency band, the bound packet is first transmitted. Then in the subframes of 2-4 ms, the bound packet is transmitted for the second time at the second RB of sub-band 2, i.e., the 27^{th} RB of the entirety frequency band.

In the method 500, the bound packet transmitted each time may be a packet of the same redundancy version or a packet of a different redundancy version. For details, please refer to the relevant description above, which will not be detailed here.

The frequency hopping pattern according to the embodiments of the present invention has been described above with reference to FIGS. 5 and 6, where a bound packet consisting of a plurality of consecutive packets is transmitted in the frequency domain with a certain frequency interval span, thereby obtaining the frequency diversity gain of the packet and enhancing the link performance.

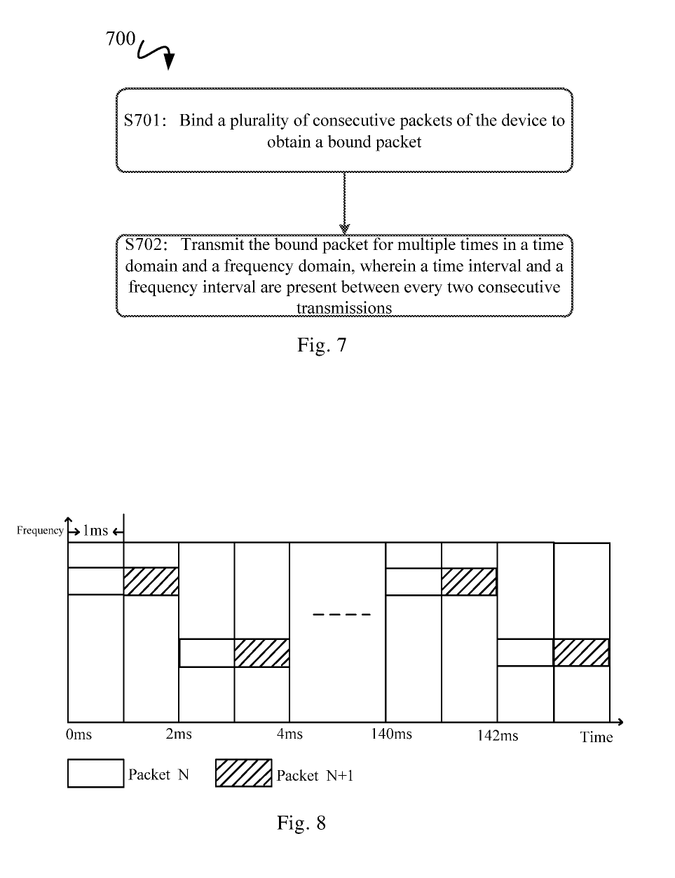

FIG. 7 shows a flow diagram of a method 700 for packet retransmission according to a further embodiment of the present invention. It should be understood that the method 700 may further comprise additional steps and/or omitting performing a shown step. The scope of the present invention is not limited in this regard.

After the method 700 starts, at step S701, a plurality of consecutive packets of the apparatus are bound to obtain a bound packet.

Step S701 is similar to step S301 and step S501, detailed depiction of which is omitted here for the sake of clarity. For details, please refer to the above depiction about step S301.

At step S702, the bound packet is transmitted for multiple times in the time domain and the frequency domain, wherein a time interval and a frequency interval are present between every two consecutive transmissions.

This step combines step S302 in method 300 and step S502 in method 500. For specific implementation, please refer to the above depictions of step S302 and step S502, which will not be detailed here.

With reference to FIG. 8, in which packet retransmission combining the time hopping pattern and the frequency hopping pattern is presented. As shown in FIG. 8, two packets (packet N and packet N+1) from the device are bound to obtain a bound packet. Suppose transmission is performed in an LTE system and each packet seizes a 1 ms subframe, then the bound packet seizes 2 subframes. During the subframes of 0-2 ms, the bound packet is first transmitted at the second RB. Then, during the subframes of 2-4 ms, the bound packet is transmitted at the 27^{th} RB, so on and so forth. Finally, in the subframes of 140-142 ms, the bound packet is transmitted again at the second RB, and in the subframes of 142 ms-144 ms, the bound packet is transmitted for the last time at the 27^{th} RB. The last transmission occurs within the tolerable transmission delay time, 160 ms.

Because in the method 700, the bound packet is not only expand transmitted in the time domain at a certain time interval, but also expand transmitted in the frequency domain at a certain frequency interval. Therefore, reception of each packet in the bound packet can not only obtain time diversity gain, but also can obtain the frequency diversity gain, so as to further enhance the link performance.

Methods for packet retransmission by a device according to the embodiments of the present invention have been described above with reference to FIGS. 3-8. The device may continuously transmit packets to be transmitted to the receiving end device according to any one of methods 300, 500, and 700.

According to a further embodiment of the present invention, a scenario of performing packet retransmission by a plurality of devices in the system may be also considered. For each device, it may perform packet retransmission according to any one of the above methods 300, 500, and 700. Meanwhile, in one example, in order to facilitate reception of the receiving end device, a same transmission time period may be set for the plurality of devices. After a plurality of consecutive packets of each device are bound to obtain a bound packet for each device, the bound packet for each packet is transmitted using a different resource block during each pre-determined transmission time period.

Herein, the resource block seizes certain time and frequency resources. In one embodiment of the present invention, a time interval of transmission time period may be present between multiple times of transmissions of the bound packet of each device. For example, in one transmission time period, the bound packet from each device is transmitted according to the time order, and between bound packets of a plurality of devices, there may be a time interval or might not be a time interval. According to a further embodiment of the present invention, the frequency seized by the bound packet for each device is different, and a frequency interval might be present between multiple transmissions of the bound packet of each device.

In the embodiments of the present invention, each device may continuously obtain to-be-transmitted packets based on the service requirements or obtain packets to be transmitted at a certain time interval. For example, for the VoIP service, a voice packet is generated every 20 ms.

If the packets to be transmitted are obtained continuously, a plurality of devices may continuously bind the packets to be transmitted to obtain bound packets, and then perform packet retransmission in order. For example, suppose there are two devices. In the time domain, the bound packet of each device may be cyclically transmitted between two devices.

If the packets to be transmitted are obtained at a certain time interval, a newly obtained bound packet may be transmitted at an interval of the obtaining time gap. During the time of not obtaining a new bound packet, the previously transmitted bound packet may be retransmitted; and a transmission time period may be spaced between two consecutive retransmissions. For example, if the obtaining time gap for a packet is 20 ms for a bound packet consisting of 2 packets, its obtaining time gap is 40 ms. The obtaining period may be divided into 2 sections. The first 20 ms is for initial transmission of the newly obtained bound packet, while the latter 20 ms is for retransmitting the previously transmitted bound packet. Then a new bound packet including two packets is transmitted at an interval of 40 ms, and the previously transmitted bound packet is transmitted again every 140 ms.

Still take the VoIP service which generates a voice packet every 20 ms as an example.

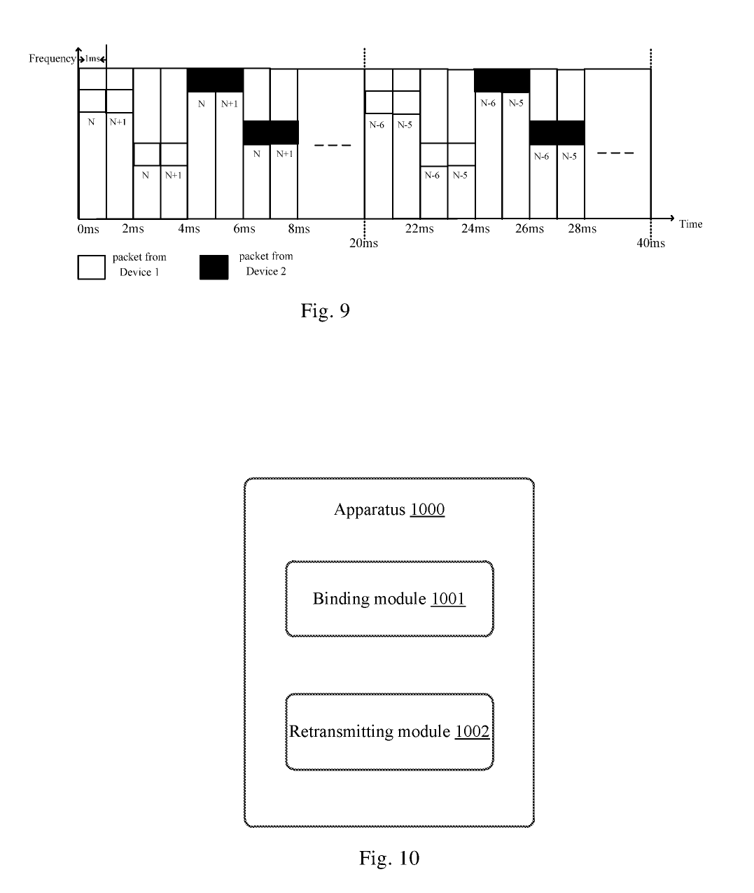

With reference to FIG. 9, in which retransmission of bound packets of two devices is presented, where the obtaining time gap for the bound packets consisting of 2 packets is 40 ms. In FIG. 9, the packet N and the packet N+1 of Device 1 is bound into a first bound packet; likewise, the packet N and the packet N+1 of Device 2 are bound into a first bound packet. During the 0-40 ms obtaining time gap, the first 20 ms is used for initial transmission, and the first bound packet of Device 1 is transmitted in the subframes of 0-2 ms, and meanwhile retransmitted during 2-4 ms at a certain frequency interval. The first bound packet of Device 2 is transmitted in the subframes of 4-6 ms, and meanwhile retransmitted during 6-8 ms at a certain frequency interval. Because the transmission time period is 140 ms, then in the later 20 ms, it is the bound packet formed by binding packet N−6 and packet N−5 of Device 1 and the bound packet formed by the same packet numbers of Device 2 that are retransmitted in a time hopping pattern. The packet number of each device indicates the obtaining sequence of the packet.

The spirit and principle of the present invention has been explained above with reference to several preferred embodiments. Through the plurality of embodiments of the present invention, a plurality of consecutive packets are bound into one bound packet, and the bound packet is transmitted for multiple times in the time domain and/or frequency domain at a time interval and/or frequency domain internal; upon reception of the packet, a joint channel estimation across a plurality of subframes may be maintained, and each packet in the plurality of consecutive packets can obtain the time diversity gain and frequency domain diversity gain, thereby enhancing link performance.

FIG. 10 shows a block diagram of an apparatus 1000 for packet retransmission according to an embodiment of the present invention, wherein the apparatus 1000 may be a base station or a user terminal or a part of the base station or user terminal; besides, the apparatus 1000 may also be a third party device for facilitating retransmitting a packet from a transmitting end device to a receiving end device.

As shown in FIG. 10, the apparatus 1000 comprises a binding module 1001 configured to bind a plurality of consecutive packets of the device to obtain a bound packet. The apparatus 1000 further comprises a retransmitting module 1002 configured to transmit the bound packet for multiple times in at least one of a time domain and a frequency domain, wherein at least one of a time interval and a frequency interval is present between every two consecutive transmissions.

According to one embodiment of the present invention, each packet included in the bound packet is a packet of the same redundancy version during multiple times of transmission. According to a further embodiment of the present invention, each packet included in the bound packet is a packet of a different redundancy version during multiple times of transmission.

According to one embodiment of the present invention, when a bound packet is transmitted for multiple times in a time domain, the time interval between every two consecutive transmissions is set to obtain a time diversity gain. According to a further embodiment of the present invention, when a bound packet is transmitted for multiple times in a time domain, the last transmission occurs within a predetermined tolerable transmission delay time.

According to one embodiment of the present invention, when a bound packet is transmitted for multiple times in a frequency domain, the frequency interval between every two consecutive transmissions is set to obtain a frequency diversity gain. According to a further embodiment of the present invention, when a bound packet is transmitted multiple times in a frequency domain, the bound packet is transmitted in a different subframe each time. According to a still further embodiment of the present invention, an entire transmission band is divided into a plurality of sub-bands, and the retransmitting module is further configured to transmit the bound packet on a different sub-band each time.

It is seen that the apparatus 1000 of FIG. 10 may implement the method as shown in FIGS. 3, 5 and 7, and although not further shown, the apparatus 1000 may comprise more functional units to implement a plurality of embodiments depicted with reference to methods 300, 500, and 700 with reference to FIGS. 3, 5 and 7. Further, the apparatus 1000 may bind a plurality of consecutive packets into a bound packet, and the bound packet is transmitted for multiple times in the time domain and/or frequency domain at a time interval and/or frequency domain internal; upon reception of the packet, a joint channel estimation across a plurality of subframes may be maintained, and each packet in the plurality of consecutive packets may obtain the time diversity gain and frequency domain diversity gain, thereby enhancing link performance.

It should be noted that the embodiments of the present invention may be implemented through hardware, software, or a combination of software and hardware. The hardware portion may be implemented through a dedicated logic; the software portion may be stored in a memory and executed by an appropriate instruction executing system, e.g., a micro processor or a dedicatedly designed hardware. A ordinary skilled person in the art may understand that the above apparatus and method may be implemented using a computer executable instruction and/or included in processor control code, e.g., a carrier medium such as disk, CD or DVD-ROM, a programmable memory such as read-only memory (firmware), or a data carrier such as optical or electronic signal carrier provides such code. The apparatus according to the present invention, as well as its modules, may be implemented by hardware circuit such as a very large-scale integrated circuit or gate array, a semiconductor such as logic chip, transistor, etc., or a programmable hardware device such as field programmable gate array, a programmable logic device, etc., or may be implemented by software executed by various kinds of software, or implemented by a combination of the above hardware circuit and software, e.g., firmware.

It should be noted that although a plurality of modules and sub-modules of the apparatus have been mentioned in the above detailed description, such dividing is only non-compulsory. Actually, according to the embodiments of the present invention, the features and functions of the above described two or more modules may be instantiated in one module. On the contrary, features and functions of one module described above may be further divided into a plurality of modules to instantiate.

Besides, although operations of the method of the present invention have been described at a particular sequence in the drawings, it does not require or suggest that these operations should be executed according to this particular sequence, or a desired result can only be achieved by performing all of the shown operations. On the contrary, the steps depicted in the flow diagram may change the execution sequence. Additionally or alternatively, some steps may be omitted; a plurality of steps may be reduced to one step for execution, and/or one step may be decomposed into a plurality of steps for execution.

Although the present invention has been described with reference to a plurality of preferred embodiments, it should be understood that the present invention is not limited to the disclosed preferred embodiments. The present invention intends to cover various amendments and equivalent arrangements included within the spirit and scope of the appended claims. The scope of the appended claims conforms to the broadest explanation, thereby covering all such amendments and equivalent structures and functions.

1. A method for packet retransmission, comprising:
binding a plurality of consecutive packets of a device to obtain a bound packet, and
transmitting the bound packet for multiple times in at least one of a time domain and a frequency domain, wherein at least one of a time interval and a frequency interval is present between every two consecutive transmissions.

2. The method according to claim 1, wherein each packet included in the bound packet is a packet of the same redundancy version during the multiple times of transmission.

3. The method according to claim 1, wherein each packet included in the bound packet is a packet of a different redundancy version during the multiple times of transmission.

4. The method according to claim 1, wherein when the bound packet is transmitted for multiple times in the time domain, the time interval between every two consecutive transmissions is set to obtain a time diversity gain; and wherein when the bound packet is transmitted for multiple times in the time domain, the last transmission occurs within a predetermined tolerable transmission delay time.

5. (canceled)

6. The method according to claim 1, wherein when a bound packet is transmitted for multiple times in the frequency domain, the frequency interval between every two consecutive transmissions is set to obtain a frequency diversity gain.

7. The method according to claim 1, wherein when a bound packet is transmitted multiple times in the frequency domain, the bound packet is transmitted in a different subframe each time.

8. The method according to claim 1, wherein an entire transmission band is divided into a plurality of sub-bands, and wherein transmitting the bound packet for multiple times in the frequency domain includes:
transmitting the bound packet on a different sub-band each time.

9. (canceled)

10. An apparatus for packet retransmission, comprising:
a first binding module configured to bind a plurality of consecutive packets of the device to obtain a bound packet;
a first retransmitting module configured to transmit the bound packet for multiple times in at least one of a time domain and a frequency domain, wherein at least one of a time interval and a frequency interval is present between every two consecutive transmissions.

11. The apparatus according to claim 10, wherein each packet included in the bound packet is a packet of the same redundancy version during the multiple times of transmission.

12. The apparatus according to claim 10, wherein each packet included in the bound packet is a packet of a different redundancy version during the multiple times of transmission.

13. The apparatus according to claim 10, wherein when a bound packet is transmitted for multiple times in the time domain, the time interval between every two consecutive transmissions is set to obtain a time diversity gain; and wherein when the bound packet is transmitted for multiple times in the time domain, the last transmission occurs within a predetermined tolerable transmission delay time.

14. (canceled)

15. The apparatus according to claim 10, wherein when a bound packet is transmitted for multiple times in the frequency domain, the frequency interval between every two consecutive transmissions is set to obtain a frequency diversity gain.

16. The apparatus according to claim 10, wherein when a bound packet is transmitted multiple times in the frequency domain, the bound packet is transmitted in a different subframe each time.

17. The apparatus according to claim 10, wherein an entire transmission band is divided into a plurality of sub-bands, and wherein the retransmitting module is further configured to transmit the bound packet on a different sub-band each time.

18. The apparatus according to claim 10, wherein the apparatus is a base station or a user terminal.
